(19) United States
(12) Patent Application Publication
(10) Pub. No.: US 2025/0094731 A1
(43) Pub. Date: Mar. 20, 2025

(54) GEOMETRICALLY GROUNDED LARGE LANGUAGE MODELS FOR ZERO-SHOT HUMAN ACTIVITY FORECASTING IN HUMAN-AWARE TASK PLANNING

(71) Applicant: SAMSUNG ELECTRONICS CO, LTD., Suwon-si (KR)

(72) Inventors: Moritz Alexander GRAULE, New York, NY (US); Ibrahim Volkan ISLER, Saint Paul, MN (US)

(73) Assignee: SAMSUNG ELECTRONICS CO, LTD., Suwon-si (KR)

(21) Appl. No.: 18/614,200

(22) Filed: Mar. 22, 2024

Related U.S. Application Data
(60) Provisional application No. 63/538,436, filed on Sep. 14, 2023.

(51) Int. Cl. G06F 40/40

(52) U.S. Cl. CPC G06F 40/40

(57) ABSTRACT

A method includes receiving data from one or more sensors, detecting, from the received data, one or more activities of a person in a space, converting the detected one or more activities into a natural language narration; extracting one or more items from a map corresponding to the space; determining a relevancy score for each of the extracted one or more items based on an output of a language model that receives as input a combination of the narration with a binding sequence; correlating the extracted one or more items with one or more locations on the map based on the determined relevancy for each of the extracted one or more items; and outputting a control signal for controlling a movement of one more devices based on the correlation of the extracted one or more items with the one or more locations on the map.

### CROSS-REFERENCE TO RELATED APPLICATION

This application claims priority to U.S. provisional application No. 63/538,436 filed on Sep. 14, 2023, the entire contents of which are incorporated herein by reference.

### BACKGROUND

### 1. Field

This disclosure is directed to utilizing geometrically grounded large language models for forecasting the control of one or more devices.

### 2. Related Art

The usage of robots and smart home appliances to perform tasks are becoming more prevalent. As robots increasingly move to settings such as warehouses, hospitals, and our homes, these robots will be required to dynamically operate in proximity to, and collaboration with, human operators. Mere reactive collision-avoidance is not sufficient to achieve safe and effective assistance in these scenarios. Rather, robots must possess the ability to proactively infer the human operators' intentions and predict their future actions and trajectories. Robots must further be able to leverage their predictions to create human-aware task and motion plans that maximize the robots' utility while minimizing undesirable interactions with humans (e.g., collisions, uncomfortable proximity, or disturbing audio). The creation of these plans requires the integration of symbolic reasoning to predict human actions and the localization of these predictions within the physical environment.

Furthermore, to meet the demands of an aging society with increasing labor shortage, robots need to work alongside and in close proximity to humans in environments such as hospitals and homes. Ensuring safe and effective operation in these human-centric environments necessitates a robot's ability to account for a human's high-level intent and future motion in the robot's task and motion plan. Generating these human-aware task and motion plans requires symbolic reasoning about probable future actions and the ability to tie these actions to specific locations in the physical environment. While behavioral models capable of predicting human motion from past activities can be trained, this approach requires large amounts of data to achieve acceptable long-horizon predictions, and the resulting models constrained to specific data formats and modalities. Moreover, connecting predictions from such models to the environment at hand to ensure the applicability of these predictions is an unsolved problem.

### SUMMARY

According to one or more embodiments, a method performed by at least one processor, comprises receiving data from one or more sensors corresponding to a first time period; detecting, from the received data, one or more activities of a person in a space; converting the detected one or more activities into a natural language narration; combining the natural language narration with sequence text that corresponds to an action that is sequential to the detected one or more activities; extracting one or more items from a map corresponding to the space; determining a relevancy score for each of the extracted one or more items based on an output of a language model that receives as input the combination of the narration with the sequence text; correlating the extracted one or more items with one or more locations on the map based on the determined relevancy for each of the extracted one or more items; and outputting a control signal for controlling a movement of one more devices based on the correlation of the extracted one or more items with the one or more locations on the map.

According to one or more embodiments, an apparatus comprising: a memory; processing circuitry coupled to the memory, the processing circuitry configured to: receive data from one or more sensors corresponding to a first time period, detect, from the received data, one or more activities of a person in a space, convert the detected one or more activities into a natural language narration, combine the natural language narration with sequence text that corresponds to an action that is sequential to the detected one or more activities, extract one or more items from a map corresponding to the space, determine a relevancy score for each of the extracted one or more items based on an output of a language model that receives as input the combination of the narration with the sequence text, correlate the extracted one or more items with one or more locations on the map based on the determined relevancy for each of the extracted one or more items, and a control signal for controlling a movement of one more devices based on the correlation of the extracted one or more items with the one or more locations on the map.

According to one or more embodiments, a non-transitory computer readable medium having instructions stored therein, which when executed by a processor cause the processor to execute a method comprising: receiving data from one or more sensors corresponding to a first time period, detecting, from the received data, one or more activities of a person in a space, converting the detected one or more activities into a natural language narration; combining the natural language narration with sequence text that corresponds to an action that is sequential to the detected one or more activities; extracting one or more items from a map corresponding to the space; determining a relevancy score for each of the extracted one or more items based on an output of a language model that receives as input the combination of the narration with the sequence text; correlating the extracted one or more items with one or more locations on the map based on the determined relevancy for each of the extracted one or more items; and outputting a control signal for controlling a movement of one more devices based on the correlation of the extracted one or more items with the one or more locations on the map.

### BRIEF DESCRIPTION OF DRAWINGS

Further features, the nature, and various advantages of the disclosed subject matter will be more apparent from the following detailed description and the accompanying drawings in which:

FIG. 1 is a diagram of an environment in which methods, apparatuses, and systems described herein may be implemented, in accordance with embodiments of the present disclosure.

FIG. 2 is a block diagram of example components of one or more devices of FIG. 1, in accordance with embodiments of the present disclosure.

FIG. 3 illustrates an example system for detecting activities and controlling one or more devices, in accordance with embodiments of the present disclosure.

FIG. 4 illustrates example device actions, in accordance with embodiments of the present disclosure.

FIG. 5 illustrates an example system architecture for detecting activities and controlling one or more devices, in accordance with embodiments of the present disclosure.

FIG. 6 is flow chart of an example process for detecting activities and controlling one or more devices, in accordance with embodiments of the present disclosure.

FIG. 7 is an example table providing example narrations and goal predictions, in accordance with embodiments of the present disclosure.

FIG. 8 illustrates an example map, in accordance with embodiments of the present disclosure.

FIG. 9 illustrates an example flowchart based on one or more observations, in accordance with embodiments of the present disclosure.

FIG. 10 illustrates an example flowchart based on one or more observations, in accordance with embodiments of the present disclosure.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware or firmware. The actual specialized control hardware used to implement these systems and/or methods is not limiting of the implementations.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure may be practiced without one or more of the specific features or advantages of a particular embodiment. In other instances, additional features and advantages may be recognized in certain embodiments that may not be present in all embodiments of the present disclosure.

Embodiments of the present disclosure are directed to an approach that produces environment-specific predictions of human motion without requiring any training on human activity data. Previous approaches for human-aware device control are either purely reactive, or they predict future human actions without connecting these actions to concrete locations in the environment, rendering long-term intent-aware task and motion planning infeasible. The embodiments of the present disclosure overcome these disadvantages by predicting future activities with a long time horizon, connecting these activities to items and locations available in the physical environment, and inferring likely human paths and needs from this information.

The embodiments of the present disclosure utilize symbolic reasoning about future human activities with large language models (LLMs). In this regard, LLMs encode substantial world knowledge by being trained on a vast corpus of text describing human behaviors including probable sequences of human actions and activities. Embodiments of the present disclosure are directed to a system that utilizes an LLM to infer a human's next actions from a range of modalities without fine-tuning, and links the predicted actions to specific locations in a semantic map of the environment. The knowledge from LLMs about a user's most likely future actions from LLMs with a targeted prompt combines a narration of a scene observation in natural language with a binding sequence that induces reasoning about future human activities.

Embodiments of the present disclosure demonstrate how these localized activity predictions may be incorporated in a human-aware task planner for an assistive robot to reduce the occurrences of undesirable human-robot interactions. The embodiments of the present disclosure not only enhance the capabilities of human-aware service robots, but also open up new possibilities for active and effective human-robot collaboration in a wide range of settings, including homes, hospitals, and any other suitable environment known to one of ordinary skill in the art.

Embodiments of the present disclosure leverages LLMs to infer a human's probable next actions while grounding these predictions in a semantic map of the environment. In this regard, the symbolic predictions of future human activities are connected to objects and locations in a semantic map, resulting in obtaining localized relevancy scores for different partitions in an environment that indicate how likely a user will go to one of these partition in the future.

In one or more examples, natural language is utilized as a versatile interface to aggregate observations from a variety of input sources (e.g., video or signals from connected appliances), ensuring adaptability to settings with diverse and variable sensing modalities. After obtaining a language-based narration of past observations, the training of LLMs on extensive text corpora depicting various human behaviors is leveraged. In this regard, the training of LLMs implicitly encode knowledge about human preferences and habits. The embodiments of the present disclosure show that the foundational understanding of human activities from LLMs may be accurately extracted to anticipate the objects with which a human is likely interacting next without additional training. In one or more examples, these predictions are grounded in the physical environment of the human by connecting the predictions to semantic map of a scene.

The embodiments of the present disclosure provide significant advantages over the conventional technologies. Existing approaches only respond to ongoing activities at a human's current position, and are unable to anticipate future needs at different locations. Embodiments of the present disclosure advantageously adjust an operation of one or more devices (e.g., autonomous robots, appliances, etc.) in anticipation of future human needs in a location-specific manner. For example, if it is observed a human donning shoes and a jacket in a foyer, the embodiments of the present disclosure determine that the human is about to leave the house and may ensure that safety-critical (e.g., stove, oven, etc.) and energy-intensive devices are turned off/down. Similarly, if it is observed that a human is preparing for a home workout, the embodiments of the present disclosure may adjust the temperature and ventilation in the workout room. Furthermore, the detection of subtle motion or gestures that indicate that the human is too cold or hot may be used for room-specific temperature control.

While existing approaches may detect the presence of humans and predict their short-term trajectories, they are unable to infer how long a person will stay in a certain area, and whether certain robot activities (e.g., vacuuming) are disruptive. Using the localized activity predictions of the embodiments of the present disclosure, autonomous robots may schedule tasks in an order that minimizes disturbances to the human (e.g., don't vacuum near a human who recently started a meeting or watching TV).

Furthermore, existing approaches rely on either (i) human proximity detection and reactive control, or (ii) predicting human trajectories based on past motion with no awareness of the human's intended goal location. Trajectories predicted in this manner are only accurate for a short-term horizon, rendering robots incapable of accounting for long-term human motion in their path and trajectory planning. A key problem in using reactive control for human avoidance is that the robot only knows to move away from the human without awareness of where the human wants to go in the long term. Therefore, based on existing approaches, the robot may repeatedly move to a location that also lies in the human's path. By predicting which goal locations are of interest to the human in the future, the embodiments of the present disclosure enable the prediction of likely human trajectories over a long time horizon. Autonomous robots may use this information for long-term planning of paths that avoid collisions or assist the human in their task. Since the embodiments of the present disclosure leverages world knowledge from LLMs, the embodiments of the present disclosure allows robots to anticipate which items or tools the human may need in the future.

The embodiments of the present disclosure may be incorporated in any system or robot operating in a workspace shared with a human operator. The system may either be operating alongside the human to solve an independent task, or actively collaborate with the human on a shared task including, for example, robot vacuum cleaners, robot home assistants with one or multiple manipulators, factory automation robots, or smart appliances.

Smooth interaction between human operators and robots/devices without unwanted disturbances, as well as effective collaboration between robots/devices and the human, result from a planning module that accounts for the user's intent during planning. This planning module utilizes knowledge about what actions the user will execute in the future, and where in their environment the user will execute these actions. Existing technologies do not provide this connection between predicted human activity and intent and environment-specific localization.

The embodiments of the present disclosure maintain a semantic map of the environment (e.g., a map containing the location, semantic label, and dimension of some or all objects in the environment). A combination of varying data streams (e.g., observations of the user, data from user devices like phones and computers, and/or data from connected home appliances, etc. . . . ) may be used. The combination of these data streams may be used to first narrate the user's current activity using a generative AI model. Subsequently, world knowledge is extracted from a generative LLM to predict what activity the user is most likely to perform next, where these predictions are associated with objects and locations in a semantic map. As such, the embodiments of the present disclosure provide a physically grounded prediction of future human activity, which may be used in a downstream task or motion planner that controls one or more devices according to where the human is predicted to be going and what activity the human is executing next.

Examples of applications include, but are not limited to: (i) smart homes that adjust light, humidity, temperature, ventilation, and appliance operation according to predicted needs of the human (e.g., adjustment based on where the human is predicted to perform a future activity); (ii) smart robot vacuum cleaners that avoid disturbing the human (e.g., doesn't clean the kitchen during cooking, doesn't clean the living room when human is watching TV, doesn't clean the home office during video meetings or deep focus) and proactively cleans areas of the house in accordance with human activity (e.g., cleans kitchen after meal preparation is completed); (iii) assistive robots that proactively fetch items the human will use next or prepare (either in home or factory setting); and (iv) wearable robots and devices that augment human function and proactively assist them in their tasks or movements.

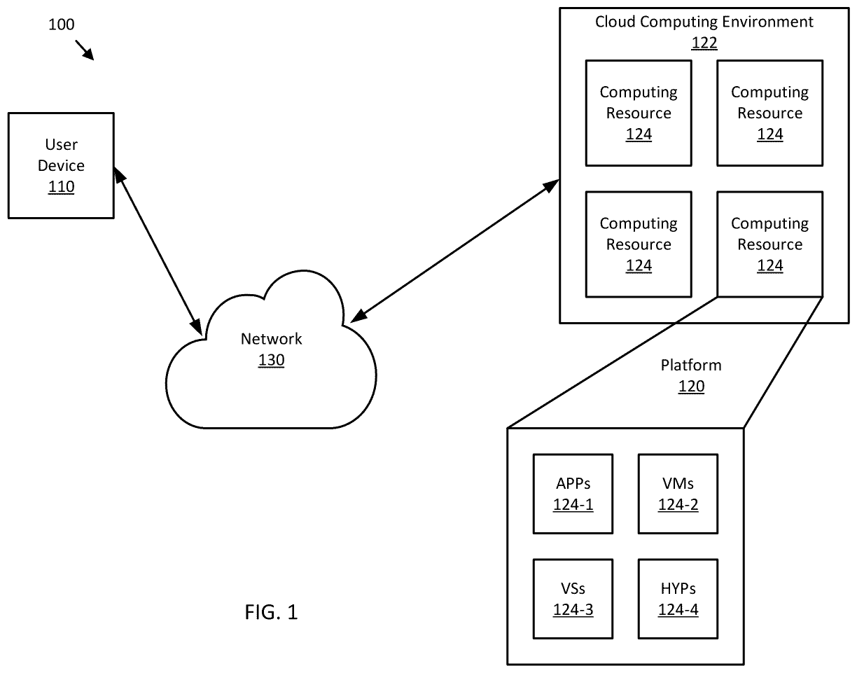

FIG. 1 is a diagram of an environment 100 in which methods, apparatuses, and systems described herein may be implemented, according to embodiments. As shown in FIG. 1, the environment 100 may include a user device 110, a platform 120, and a network 130. Devices of the environment 100 may interconnect via wired connections, wireless connections, or a combination of wired and wireless connections.

The user device 110 includes one or more devices capable of receiving, generating, storing, processing, and/or providing information associated with platform 120. For example, the user device 110 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, the user device 110 may receive information from and/or transmit information to the platform 120.

The platform 120 includes one or more devices as described elsewhere herein. In some implementations, the platform 120 may include a cloud server or a group of cloud servers. In some implementations, the platform 120 may be designed to be modular such that software components may be swapped in or out depending on a particular need. As such, the platform 120 may be easily and/or quickly reconfigured for different uses.

In some implementations, as shown, the platform 120 may be hosted in a cloud computing environment 122. Notably, while implementations described herein describe the platform 120 as being hosted in the cloud computing environment 122, in some implementations, the platform 120 may not be cloud-based (i.e., may be implemented outside of a cloud computing environment) or may be partially cloud-based.

The cloud computing environment 122 includes an environment that hosts the platform 120. The cloud computing environment 122 may provide computation, software, data access, storage, etc. services that do not require end-user (e.g. the user device 110) knowledge of a physical location and configuration of system(s) and/or device(s) that hosts the platform 120. As shown, the cloud computing environment 122 may include a group of computing resources 124 (referred to collectively as “computing resources 124” and individually as “computing resource 124”).

The computing resource 124 includes one or more personal computers, workstation computers, server devices, or other types of computation and/or communication devices. In some implementations, the computing resource 124 may host the platform 120. The cloud resources may include compute instances executing in the computing resource 124, storage devices provided in the computing resource 124, data transfer devices provided by the computing resource 124, etc. In some implementations, the computing resource 124 may communicate with other computing resources 124 via wired connections, wireless connections, or a combination of wired and wireless connections.

As further shown in FIG. 1, the computing resource 124 includes a group of cloud resources, such as one or more applications (APPs) 124-1, one or more virtual machines (VMs) 124-2, virtualized storage (VSs) 124-3, one or more hypervisors (HYPs) 124-4, or the like.

The application 124-1 includes one or more software applications that may be provided to or accessed by the user device 110 and/or the platform 120. The application 124-1 may eliminate a need to install and execute the software applications on the user device 110. For example, the application 124-1 may include software associated with the platform 120 and/or any other software capable of being provided via the cloud computing environment 122. In some implementations, one application 124-1 may send/receive information to/from one or more other applications 124-1, via the virtual machine 124-2.

The virtual machine 124-2 includes a software implementation of a machine (e.g. a computer) that executes programs like a physical machine. The virtual machine 124-2 may be either a system virtual machine or a process virtual machine, depending upon use and degree of correspondence to any real machine by the virtual machine 124-2. A system virtual machine may provide a complete system platform that supports execution of a complete operating system (OS). A process virtual machine may execute a single program, and may support a single process. In some implementations, the virtual machine 124-2 may execute on behalf of a user (e.g. the user device 110), and may manage infrastructure of the cloud computing environment 122, such as data management, synchronization, or long-duration data transfers.

The virtualized storage 124-3 includes one or more storage systems and/or one or more devices that use virtualization techniques within the storage systems or devices of the computing resource 124. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

The hypervisor 124-4 may provide hardware virtualization techniques that allow multiple operating systems (e.g. “guest operating systems”) to execute concurrently on a host computer, such as the computing resource 124. The hypervisor 124-4 may present a virtual operating platform to the guest operating systems, and may manage the execution of the guest operating systems. Multiple instances of a variety of operating systems may share virtualized hardware resources.

The network 130 includes one or more wired and/or wireless networks. For example, the network 130 may include a cellular network (e.g. a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g. the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g. one or more devices) of the environment 100 may perform one or more functions described as being performed by another set of devices of the environment 100.

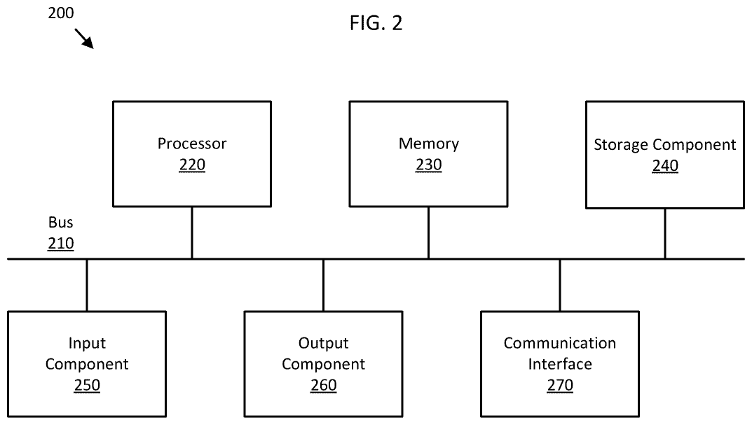

FIG. 2 is a block diagram of example components of one or more devices of FIG. 1. The device 200 may correspond to the user device 110 and/or the platform 120. The device 200 may be any other suitable device such as a TV, wall panel, etc. As shown in FIG. 2, the device 200 may include a bus 210, a processor 220, a memory 230, a storage component 240, an input component 250, an output component 260, and a communication interface 270.

The bus 210 includes a component that permits communication among the components of the device 200. The processor 220 is implemented in hardware, firmware, or a combination of hardware and software. The processor 220 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, the processor 220 includes one or more processors capable of being programmed to perform a function. The memory 230 includes a random access memory (RAM), a read only memory (ROM), and/or another type of dynamic or static storage device (e.g. a flash memory, a magnetic memory, and/or an optical memory) that stores information and/or instructions for use by the processor 220.

The storage component 240 stores information and/or software related to the operation and use of the device 200. For example, the storage component 240 may include a hard disk (e.g. a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 250 includes a component that permits the device 200 to receive information, such as via user input (e.g. a touch screen display, a keyboard, a keypad, a mouse, a button, a switch, and/or a microphone). Additionally, or alternatively, the input component 250 may include a sensor for sensing information (e.g. a global positioning system (GPS) component, an accelerometer, a gyroscope, and/or an actuator). The output component 260 includes a component that provides output information from the device 200 (e.g. a display, a speaker, and/or one or more light-emitting diodes (LEDs)).

The communication interface 270 includes a transceiver-like component (e.g., a transceiver and/or a separate receiver and transmitter) that enables the device 200 to communicate with other devices, such as via a wired connection, a wireless connection, or a combination of wired and wireless connections. The communication interface 270 may permit the device 200 to receive information from another device and/or provide information to another device. For example, the communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

The device 200 may perform one or more processes described herein. The device 200 may perform these processes in response to the processor 220 executing software instructions stored by a non-transitory computer-readable medium, such as the memory 230 and/or the storage component 240. A computer-readable medium is defined herein as a non-transitory memory device. A memory device includes memory space within a single physical storage device or memory space spread across multiple physical storage devices.

Software instructions may be read into the memory 230 and/or the storage component 240 from another computer-readable medium or from another device via the communication interface 270. When executed, software instructions stored in the memory 230 and/or the storage component 240 may cause the processor 220 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, the device 200 may include additional components, fewer components, different components, or differently arranged components than those shown in FIG. 2. Additionally, or alternatively, a set of components (e.g. one or more components) of the device 200 may perform one or more functions described as being performed by another set of components of the device 200.

In one or more examples, the device 200 may be a controller of a smart home system that communicates with one or more sensors, cameras, smart home appliances, and/or autonomous robots. The device 200 may communicated with the cloud computing environment 122 to offload one or more tasks.

According to one or more embodiments, in an example indoor environment setting, a robot agent is executing a task (e.g., cleaning, inspection, or surveillance) that requires the robot to visit all rooms of the example indoor environment.

In one or more examples, a disturbance may refer to many types of activities including, but not limited to, being within sight or earshot of a human, being closer than a certain distance to the human, or occupying the same room (or room partition) as the human. In one or more examples, same-room occupation may be defined as a disturbance.

In one or more examples, the objective of the robot agent is to achieve full floor plan coverage while minimizing the total disturbances. Additional desirable outcomes of the robot task planner include optimizing job task completion (e.g., achieve full coverage quickly), and optimal task distribution (e.g., even distribution among the time spent in each room). The following two metrics for these secondary objectives may be defined as follows: the time to achieve full coverage for the first time, and the variance across the accumulated room occupation times at the end of the planning horizon.

In one or more examples, a human is executing a sequence of activities of daily living (e.g., doing the dishes), where each activity consists of one or multiple atomic actions (e.g., collecting dishes, loading the dishwasher, starting the dishwasher, etc.). These various activities result in a sequence of human atomic actions with varying duration. If this sequence is known and each atomic action implies a deterministic room occupation, an optimal room sequence for the robot's task may be obtained by solving the corresponding mixed integer linear problem. However, in real-world applications, the series of human actions is not known, rendering the above planning approach infeasible. Instead, the robot's knowledge is limited to partial observations of the human's past atomic actions. The robot may also receive information concerning the status of the indoor environment and various network-enabled devices and appliances contained therein. If the human were to follow a probabilistic policy in which the human selects a room to occupy uniformly at random from all available rooms at each time point, the optimal robot policy would be to either randomly select a room from all rooms at each transition point or to follow a fixed permutation of rooms.

The embodiments of the present disclosure provide a system that improves upon policies that assume fully randomized human room occupation by leveraging the insight that past human actions exhibit correlations with future actions, and that human actions are intrinsically linked to the objects and elements in their environment.

According to one or more embodiments, the system includes a symbolic-geometric reasoning module. This module reasons about plausible sequences of actions at the symbolic level. The system predicts probable next actions based on past actions and anticipates the potential items with which the human is likely to interact next.

In one or more examples, as effective planning for human-aware robot behavior necessitates environment-aware geometric reasoning, these symbolic predictions in the physical environment using a semantic map, which contains the bounding boxes and semantic labels for each room and object instance (e.g., multiple object instances can share the same semantic label). In one or more examples, the robotic agent uses these geometrically grounded predictions of probable future human actions to reduce disturbances to the human as the human moves through the environment, or aids the human in performing a task.

According to one or more embodiments, the system architecture includes three sequential modules: a narrator module, a symbolic-geometric reasoning module, and an intent-aware planning module. Each of these modules may be incorporated within the device 200 (FIG. 2). The narrator module may receive observations from various sources such as video feeds from a robot or environment (e.g., apartment) cameras, and data streams from connected devices and appliances, aggregates these observations, and creates a natural language description of the human's past actions and the apartment state.

In one or more examples, the symbolic-geometric reasoning module comprises two submodules: symbolic reasoning submodule and geometric grounding submodule. The symbolic reasoning submodule may analyze past actions and assign a score to each object within the environment, which reflects the likelihood of human interaction with the object in the near future. The geometric grounding submodule may localize these object scores within the semantic map and aggregate scores across different subsections of the scene, where a subsection may include a room partition, a full room, or multiple rooms. This process may yield an aggregate score for each subsection which is proportional to the predicted probability of future human occupancy of the subsection.

In one or more examples, the intent-aware planning module may leverage the spatially aggregated scores generated by the symbolic-geometric reasoning module to decide in which subsection the robot should operate next.

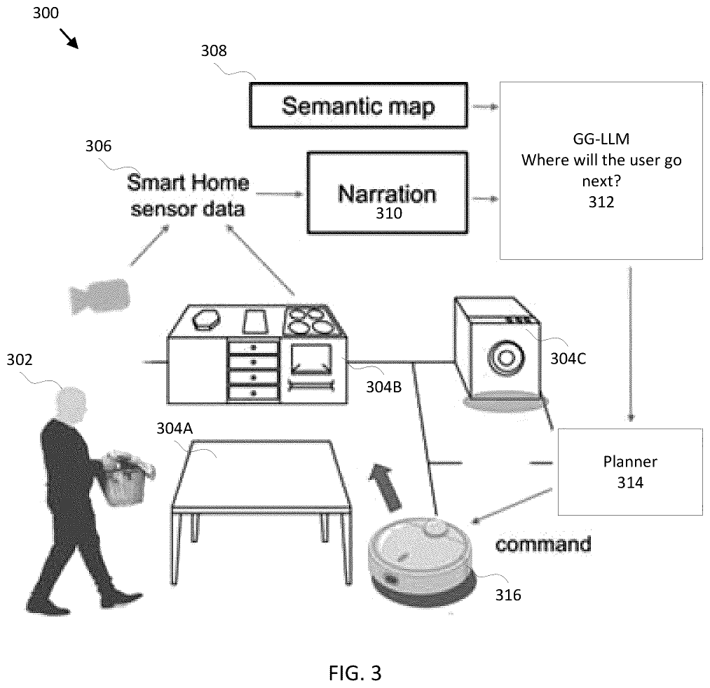

FIG. 3 illustrates an example system 300 operating in an example indoor environment (e.g., apartment). In one or more examples, a user/human is performing one or more daily activities (e.g., carrying laundry). The indoor environment may include one or more items such as a kitchen table 304A, a kitchen stove 304B, and a laundry machine 304C.

The system 300 may be in communication with one or more sensors 306 providing smart home sensor data 306. For example, the indoor environment may be equipped with one or more cameras that capture an image of the person 302 to provide image data as the smart home sensor data 306. In one or more examples, the indoor environment may include one or more motion sensors for capturing a motion of the human 302 to provide motion data as the smart home sensor data 306. The smart home sensor data 306 may be used to observe the activities of the person 302. For example, based on image analysis of image data included in the smart home sensor data 306, it may be determined that the person 302 is carrying a laundry basket containing clothes.

In one or more examples, the smart home sensor data 306 may be provided a narration module 210 to generate a narration corresponding to the person's activities. For example, if the smart home sensor data 306 is an image of person 302, image recognition may be performed on the image to determine that the person 302 is carrying a laundry basket. Therefore, the narration module 310 may output a natural language narration corresponding to “A human is carrying a laundry basket.” In one or more example, the natural language narration may be combined with a binding sequence that indicates a next action. For example, the combination of the natural language narration with the binding sequence may be: “A human is carrying a laundry basket. Next, they are going to the . . . .”

In one or more examples, the indoor environment may be described a semantic map 308. A semantic map may include a collection of items i, where each item i is associated with a semantic label 1, a position p and a bounding box. For example, the semantic map 308 may include a separate semantic label 1, position p, and bounding box for each of items 304A (kitchen sink), 304B (kitchen table), and 304C (laundry machine). An example semantic map is provided in Table 1 below.

TABLE 1

| Item | Label l | Position p | Bounding Box |
|---|---|---|---|
| Kitchen Sink | A kitchen sink is | X1, Y1 | (Xmin1, Xmax1) |
| | provided against a wall | | (Ymin1, Ymax1) |
| | of the kitchen | | (Zmin1, Zmax1) |
| Kitchen Table | A kitchen table is | X2, Y2 | (Xmin2, Xmax2) |
| | provided 5 ft from an | | (Ymin2, Ymax2) |
| | entrance of the kitchen | | (Zmin2, Zmax2) |
| Laundry Machine | A laundry machine | X3, Y3 | (Xmin3, Xmax3) |
| | provided in a laundry | | (Ymin3, Ymax3) |
| | room located next to | | (Zmin3, Zmax3) |
| | the kitchen. | | |

As illustrated in Table 1, each item may be provided with a label that describes the item. Furthermore, each item may have a position p specified as a 2D coordinate. Additionally, each item may have a bounding box that specifies the size of the bounding box in three dimensions.

The semantic map 308 and the output of the narration module 310 may be provided to a symbolic reasoning and geometric grounding module 312 to determine where the person 302 will go next. For example, based on the semantic map 308 and output of the narration module 310, the symbolic reasoning and geometric grounding module 312 may provide a relevancy score for each item as follows:

A human is carrying a laundry basket. Next they are going to the . . .
. . . kitchen table. [p=. 06]
. . . kitchen sink. [p=. 09]
. . . couch. [p=. 07]
. . . laundry machine [p=. 078]

As illustrated above, the human carrying a laundry basket is predicted to go to the laundry machine with the highest probability.

The symbolic reasoning and geometric grounding module 312 may further perform geometric grounding that localizes and aggregate relevancy scores. For example, the relevancy scores within a same partition may be aggregated. For example, the relevancy scores of each item in the kitchen may be aggregated into a first relevancy score, while the relevancy scores for each item in the living room may be aggregated into a second relevancy score.

In one or more examples, the output of the symbolic reasoning and geometric grounding module 312 may be provide to a planner module 314. The planner module 314 may perform intent-aware task planning for a robot 316 (e.g., autonomous vacuum cleaner) based on the aggregated relevancy score. For example, based on the relevancy scores, the planner 314 may set a status of different rooms as follows:

| | |
|---|---|
| Kitchen: | currently occupied |
| Laundry room: | high task relevance |
| Living room: | low task relevance |

Therefore, based on the output of the planner 314, the robot 316 may adjust one or more tasks. For example, the robot may avoid the kitchen while shifting tasks to the living room. In this regard, it may be determined that based on an image of a person carrying a laundry basket, and based on the semantic map 308, the person is likely headed to the laundry room through the kitchen. Therefore, a robot performing cleaning may avoid the laundry room while the person is in the laundry room to avoid interfering or disturbing the person.

In one or more examples, each of the narration module 310, symbolic reasoning and geometric grounding module 312, and the planner 314 may be performed by processing circuitry such as the processor 202.

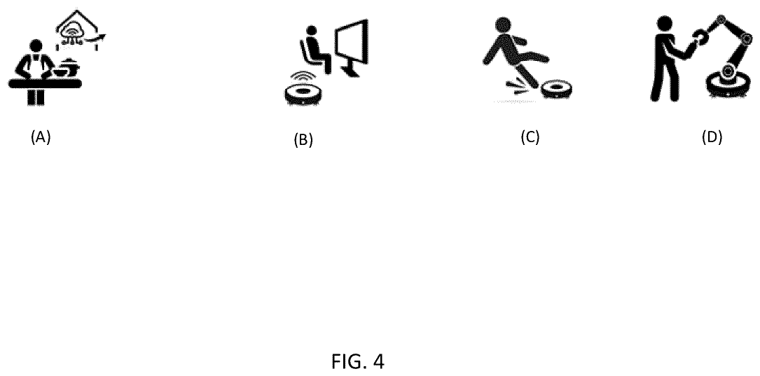

FIG. 4 illustrates example interactions between a robot and a person. For example, in scenario (A), appliances may be controlled based on a user's activities. For example, if a captured image of a user shows that the user is rolling dough, a control signal may be sent to smart appliance such as an oven to preheat to 350 degrees. In scenario (B), if a captured image of a user is watching TV, a control signal may be sent to an autonomous vacuum cleaner to avoid disrupting the user's watching of content on the TV. In scenario (C), if a captured image shows that a user is occupying a particular area, a control signal may be sent to a robot to avoid collision with the user. In scenario (D), if a captured image of a user shows that the user is carrying an item, a control signal may be sent to the robot to assist the user with the item (e.g., extension of robotic arm to hold item for the user).

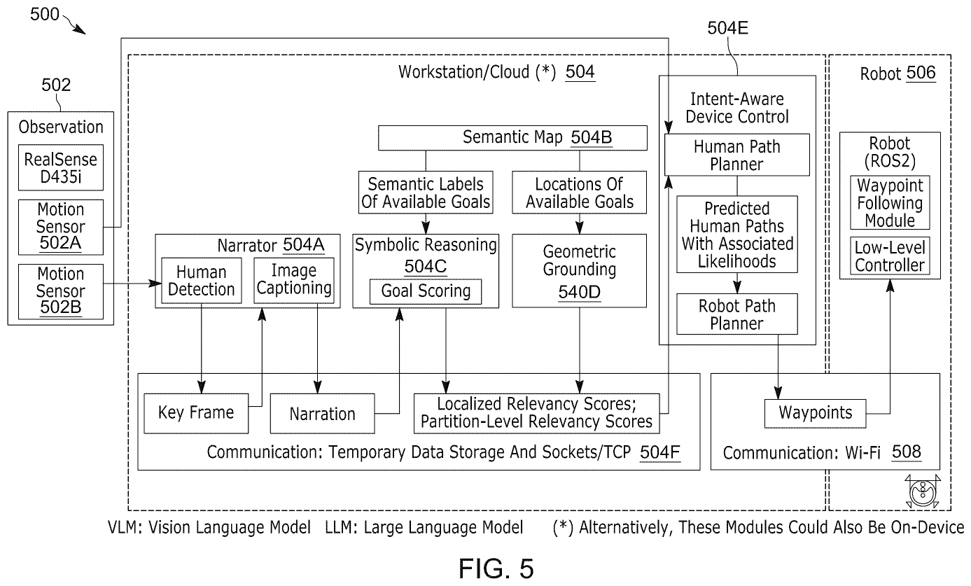

FIG. 5 illustrates an example system architecture 500 according to one or more embodiments.

In one or more examples, the system architecture includes an observation module 502, a workstation/cloud 504, and one or more robots 506. In one or more examples, the workstation/cloud 504 may be any device containing a processor as illustrated in FIG. 2. In one or more examples, the workstation cloud 504 may be a device that communicates with a cloud computing environment 122 (FIG. 1) for performing one or more computing tasks.

The observation module 502 may be composed of one or more sensors or cameras. For example, the observation module 502 may include a position sensor 502A for detecting a position of a person, or a camera 502B for capturing an image or video stream of the person such as the person 302 in FIG. 3. In one or more examples, the observation module 502 may include a sensor configured to provide depth perception capabilities of items in an environment.

In one or more examples, the system architecture 500 includes a narrator module 504A. The narrator module 504A may receive data from the observation module 502. The narrator module 504A may receive a set of observations from robot sensors, network-enabled appliances, and any other sensor that records a human. The narrator module 504A may aggregate these observations into an observation history object that includes the observations of the current and last n_h time steps. The narrator module may transform the history object into a natural language narration of the history N_h. The narrator module may leverage image or video captioning models and models trained to detect human activities to transcribe camera data to natural language. The output of the narrator module 504A may be N narration prompts.

In one or more examples, a semantic map 504B may be a closed-vocabulary collection of items, where each item is associated with a semantic label, a position, and a bounding box. Multiple items may have the same semantic label (e.g., there can be multiple item instances of type mug in a scene), and bounding boxes may be overlapping. The map may also include room-level bounding boxes. For example, the bounding box of an item may indicate the size or dimensions of an item, and a room-level bounding box may specify the size or dimensions of a room. In one or more examples, room-level bounding boxes may correspond to a partition of a room.

The system architecture 500 may include a symbolic reasoning module 504C. The symbolic reasoning module 504C may predict which objects a user is likely interacting with next. The symbolic reasoning module 504C may take as input the language narration of the history object N_h, as well as a list of items available in the environment, which may be extracted from the semantic map M. The symbolic reasoning module may assign a relevance score s_i to each of the items in M.

While it is possible to learn the mapping from past actions to relevance scores for each item, this approach requires extensive data and computational power due to the large variability in human activities and preferences. Embodiments of the present disclosure overcome this challenge by leveraging the world knowledge encoded within LLMs, which enables achievement of zero-shot symbolic reasoning about human behaviors.

In one or more example, relevant world knowledge is extracted from an LLM as follows. First, a prompt may be constructed that combines the history narration N_h with a binding sequence B designed to induce the language model to reason about what the human will do next. As an example, the binding sequence B may be “Next, the human will go to the . . . ”. In one or more examples, the symbolic reasoning module 504C may retrieve an appropriate binding sequence B from a database storing a plurality of binding sequences.

Next, a set of possible completions C is generated of the prompt N_h+B, where + indicates string concatenation. While it may be possible to rely on language models to generate C, it may be challenging to ensure in a principled way that this approach yields a C which covers all relevant items and room sections within the environment. Therefore, in one or more examples, C may be generated by extracting the semantic labels of all items from semantic map M.

Next, the relevance score for each completion c_i may be computed based on a total probability that LLM assigns to item i when conditioned on narration N_h and binding sequence B. In one or more examples, model-specific tokenizations of N_h+B may be obtained. The relevance score for completion c_i (e.g., termed the completion relevance score s_{c,i}) may be computed as the probability that the language model assigns to the tokenization of c_i as a continuation of the sequence N_h+B. For example, referring to FIG. 3, the kitchen table 304A, kitchen sink 304B, and laundry machine 304C belong to the set of completions C, where a relevance score is provided for each of these items.

Next, item-level relevance score s_i may be assign to each item in the semantic map as follows:

$$s\_i = {s}_{c , i} / n\_i , \qquad Eq . ( l ) :$$

where n_i is the number of occurrences of the semantic label associated with respective item.

In one or more examples, the completion relevance score s_{c,i} may be determined as follows:

$${s}_{c , i} = {\prod }_{j = 1}^{{l}_{i}} pM ( {c}_{i}^{- j} \vert \overline{N} + \overline{B} + {c}_{i}^{- 1 : j - 1} ) \qquad Eq . ( 2 ) :$$

In Eq. (2), P_{M}(zₙ₊₁|z₁, . . . , zₙ) represents the probability that the LLM assigns to token zₙ₊₁ as a continuation of the sequence z₁, . . . , zₙ.

In one or more examples, the symbolic reasoning module 504C may perform goal scoring using an ensemble of L language models/prompts. Each goal may be scored with each model/prompt in the scoring ensemble for each narration, which results in N×L predictions for the localized relevancy scores for each available goal. A final localized relevancy score may be obtained for each goal location as the mean across the ensemble predictions. Furthermore, an estimate for uncertainty in the relevancy scores may be obtained as a standard deviation across the ensemble predictions.

The system architecture 500 may include a geometric grounding module 504D. In one or more examples, the geometric grounding module 504D may receive the relevance scores s_i for each item in the semantic map and aggregate these scores across different spatial subdivisions of the scene. These subdivisions may encompass room partitions, entire rooms, or even multiple rooms. For example, the scores for each item in the kitchen may be aggregated to produce a first aggregated score, while the scores for each item in the living room may be aggregated to produce a second aggregated score. In another example, the scores for each item for both the kitchen and the living room may be aggregated to produce a first aggregated score, and the scores for each item included in one or more items in an upper level of an environment may be aggregated to produce a second aggregated score.

The output of the geometric grounding module 504D may be a partition-level relevance score S_j for the j-th spatial partition P_j. The score S_j may be obtained by first assigning each item to the subdivision with which its bounding box b_i has the largest overlap, and then calculating the partition-level relevance score as the sum of the item-wise relevance scores of all items within a given partition. The overlap may be represented as follows:

$$V\_o ( b\_i , P\_j ) , \qquad Eq . ( 3 ) :$$

where V_o may be the overlap volume between bounding box b_i and partition P_j, and I(−) the indicator function.

The partition-level relevance score may be computed as follows:

$${\overline{S}}_{j} = {\sum }_{i} {S}_{i} \cdot I ( arg {max}_{k} {V}_{o} ( {b}_{i} , {P}_{k} ) = j ) \qquad Eq . ( 4 ) :$$

The system architecture 500 may include an intent aware device control module 504E. The intent aware device control module 504F may receive the relevancy scores from the geometric grounding module 504D. The intent aware device control module 504F may further receive sensor data from the observation module 502. The output of the intent aware device control module 504E may be a control signal that controls one or more devices such as a smart home appliance or an autonomous robot.

In one or more examples, the intent-aware planning module 504E may define a policy π({S̅ⱼ}) which selects the future partition FPⱼ to which the robot should move to as a function of the set of partition-level relevance scores. The embodiments of the present disclosure may use one of the following policies: naïve, greedy, and informed avoidance.

In one or more examples, the naïve policy πN({S̅ⱼ}) may randomly select the next partition as follows:

$${FP}_{j} = RS ( \{ {P}_{j} \} ) , \qquad Eq . ( 5 ) :$$

where RS (A) denotes a function that randomly selects an element from the set A.

In one or more examples, the greedy policy π_{G}({S̅ⱼ}) may choose the partition with the lowest relevance score as follows:

$${FP}_{j} = arg {max}_{{P}_{i}} \{ {\overline{S}}_{i} \} \qquad Eq . ( 6 ) :$$

In one or more examples, the informed avoidance policy π({S̅ⱼ}) may discard the partition with the highest relevance score and randomly selects from the remaining partitions as follows:

$${FP}_{j} = RS ( \{ {P}_{k} \vert {\overline{S}}_{k} \neq {max}_{{P}_{i}} \{ {\overline{S}}_{i} \} ) \qquad Eq . ( 7 ) :$$

In one or more examples, the intent aware device control module 504E may output a control signal for controlling one or smart home appliances. For example, the control signal may result in regulating smart home appliances (e.g., light, temperature, humidifier, ventilation, air purifier) based on type and location of predicted future activities. For example, the control signal may increase ventilation when the GG-LLM anticipates a cooking activity. In another example, the control signal may adjust ventilation and temperature when the GG-LLM anticipates a home workout.

In one or more examples, the intent aware device control module 504E may output a control signal for controlling assistive robots. For example, the control signal may instruct a robot (e.g., autonomous vacuum) to avoid a human to avoid disturbances to the human while they are watching TV, cooking, or working. This avoidance may be achieved with task scheduling policies that prioritize task execution in partitions with lower relevancy scores. In another example, the control signal may control a robot to perform smart cleaning scheduling. For example, if it is predicted that a person finished meal preparation and went to a different room to eat, the control signal instructs the robot to clean the kitchen.

In one or more examples, the intent aware device control module 504E may perform motion planning and trajectory optimization for assistive robots. For example, the intent aware device control module may operate as a path/trajectory planner to predict possible paths/trajectories that the human may take from their current position to the top-k most likely goal locations, which may be k partitions with the highest relevancy scores. The intent aware device control module may assign a likelihood to each of the predicted human paths/trajectories, where the likelihood of each path/trajectory may be proportional to the relevancy score of its respective goal location.

The intent aware device control module 504E may perform robot motion planning. For example, robot motion planning may result in penalizing robot paths/trajectories that intersect with the predicted human trajectories (e.g., planning accounts for the likelihood of each human path/trajectory). For example, in optimization-based trajectory planning, this may be achieved through a term in the cost function that penalizes intersection with the predicted human path with a penalty that increases with increasing likelihood for a given human path. In another example, a robot trajectory may be planned to meet the human at a desired location to assist with a task or hand receive/over objects. For example, a robot may receive a control signal that instructs the robot to help a person put away groceries or tidy up without blocking their path as they execute a different task. In another example, a robot may receive a control signal that instructs the robe to provide a person with tools/items relevant to the task they are executing. In another example, a robot may receive a control signal to assist a human in carrying items. In other examples, a robot may receive a control signal to that instructs the robot, which may be a vacuum cleaner, to clear the way after recognizing that the person is walking from their bedroom to the bathroom and crossing the living room on their way.

In one or more examples, each of the narrator module 504A, symbolic reasoning module 504C, and geometric grounding module 504D may communicate with each other and retrieve data via a communication module 504F. The communication module 504F may include the bus 210 (FIG. 2) that allows these modules to communicate with each other. The communication module 504F may further include a memory 230 (FIG. 2) in which data is retrieved via the bus 210. In one or more examples, the semantic map 504B may be stored in the memory 230. In one or more example, the narrator module 504A may retrieve a keyframe from the communication module 504F. The keyframe may be frame from a video stream or series of images that is most likely to provide an indication of a person's future activity (e.g., keyframe is a frame showing a person walking in a particular direction or holding an object).

In one or more examples, the intent-aware device control 504E may communicate with the robot 506 via any communication method known to one of ordinary skill in the art. For example, the intent-aware device control 504E may communicate with the robot 506 via a Wi-Fi connection 508. In one or more examples, the intent-aware device control 504E may transmit one or more control signals to the robot 506 via the Wi-Fi connection 508. The one or more control signals may include one or more waypoints that define a path the robot will take to either avoid a person or assist a person. In one or more examples, the narrator module 504A provides a natural language narration to the symbolic reasoning module 504C via the communication module 504F. In one or more examples, the symbolic reasoning module 504C provides the relevancy scores to the geometric grounding module via the communication module 504F.

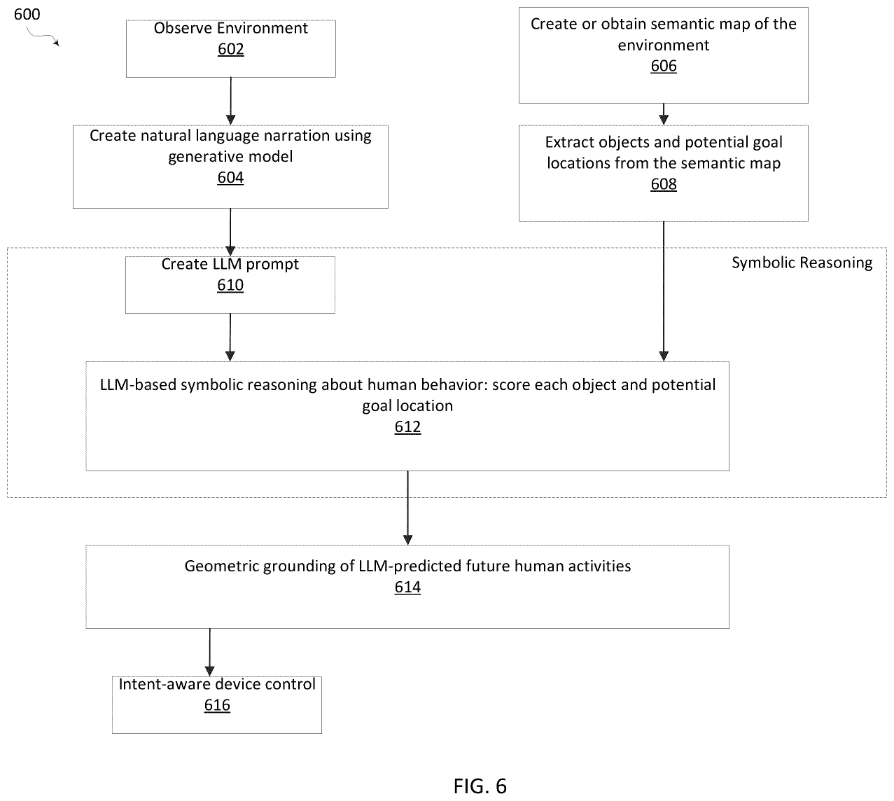

FIG. 6 illustrates a flowchart of an example process 600 for controlling one or more devices based on predicted user activity. The process 600 may be performed by a device that includes a processor such as processor 202 (FIG. 2).

The process may start at operation 602 where an environment is observed. For example, operation 602 may be performed by the observation module 502 where image data/video data, audio data from smart home appliances (e.g., laundry completion), and data from personal electronic devices is collected.

In operation 604, a natural language narration using a generative model is created. For example, operation 604 may be performed by the narrator module 504A. In one or more examples, observation data obtained via operation 602 may be turned into a natural language narration. For example, image or video data may be turned into a natural language description by using a generative image or video captioning model.

In parallel with operations 602 and 604, operations 606 and 608 may be performed. In operation 606, a semantic map of an environment may be obtained or created. For example, a semantic map 606 may be created based on observation data obtained by the observation module 502. In this regard, one or more cameras may be used to capture images of an environment to capture a semantic map. In one or more examples, a predetermined semantic map may be retrieved from memory. The process proceeds to operation 608 where objects and potential goal locations are extracted from the semantic map. In one or more example, the objects may be extracted based on being within a predetermined threshold of a user (e.g., extract all objects within a 15 ft radius of a user's current position).

After operations 602-608 are performed, symbolic reasoning operations may be performed. For example, the process may proceed to operation 610 where an LLM prompt is created. For example, the LLM prompt may be created by the symbolic reasoning module 504C. In one or more examples, the LLM prompt is created by combining a narration with a binding sequence that include a language model to reason about future human activities (e.g., the binding sequence may be “Next, they are going to the . . . ”).

The process proceeds to operation 612 where LLM-based symbolic reasoning is performed. For example, in operation 612, the LLM prompt and objects extracted from the semantic map 608 may be inputted into an LLM to obtain a score for each object extracted from the map. In one or more examples, Eq. (2) may be used to assign a relevancy score to each object/goal candidate based on an LLM predicted likelihood that a given goal occurs as a continuation of the prompt. In one or more examples, the relevancy scores may be normalized such that the relevancy scores sum up to 1.

The process proceeds to operation 614 where geometric grounding of LLM predicted future human activities is performed. In one or more examples, operation 614 may be performed by geometric grounding module 504D. In one or more examples, object-level relevancy scores are connected to map locations. Furthermore, object-level relevancy scores across partitions of the environment may be aggregated (e.g., sum scores within sub-volumes). These partitions may be rooms in an indoor environment, or smaller or larger sections of the map (e.g., partition may be two or more rooms or a sub-area of a room). The resulting partition-level relevancy scores may represent a likelihood that a human will execute activities in a respective partition in the near future.

The process proceeds to operation 616 where intent-aware device control is performed. For example, operation 616 may be performed by the intent-aware device control module 504E as described above.

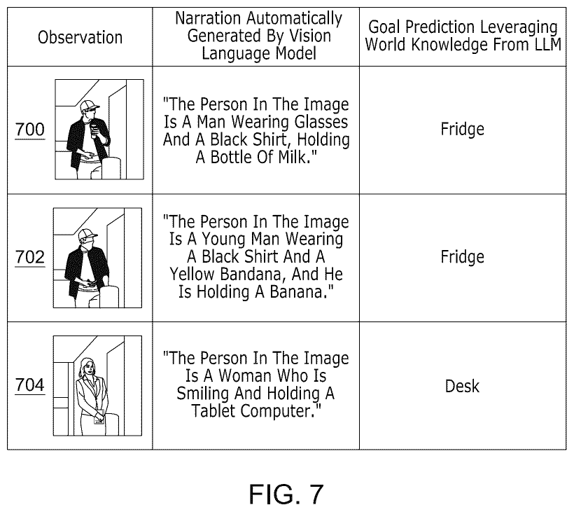

FIG. 7 illustrates a table illustrating example narrations and goal predictions. The first column illustrates three different images as observations. The images may be provided by the observation module 502. For example, the images may be taken by a camera in an environment. The first row shows an image 700 of a person holding a bottle of milk. Accordingly, when image 700 is provided to a vision language model, the narration “The person in the image is a man wearing glasses and a black shirt, holding a bottle of milk” may be generated. This narration may be combined with a binding sequence B (e.g., “Next, the person will go to . . . ”) that is provided to an LLM. One or more items (e.g., fridge, desk, microwave) may be extracted from a semantic map and provided to an LLM with the narration combined with the binding sequence B. The LLM may provide a relevancy score for each of the items. Based on geometric grounding, as described above, the item “Fridge” may have the highest relevance score. Accordingly, the goal prediction for the observation containing image 700 may be “Fridge.”

The second row of FIG. 7 illustrates an image 702 of a person holding a banana. Accordingly, when image 702 is provided to a vision language model, the narration “The person in the image is a young man wearing a black shirt and a yellow bandana, and he is holding a banana.” When this narration is combined with a binding sequence and inputted into an LLM, the item “Fridge” may be determined as a goal prediction.

The third row of FIG. 7 illustrates an image 704 of a person holding a table computer. Accordingly, when image 704 is provided to a vision language model, the narration “The person in the image is a woman who is smiling and holding a table computer.” When this narration is combined with a binding sequence and inputted into an LLM, the item “Desk” may be determined as a goal prediction.

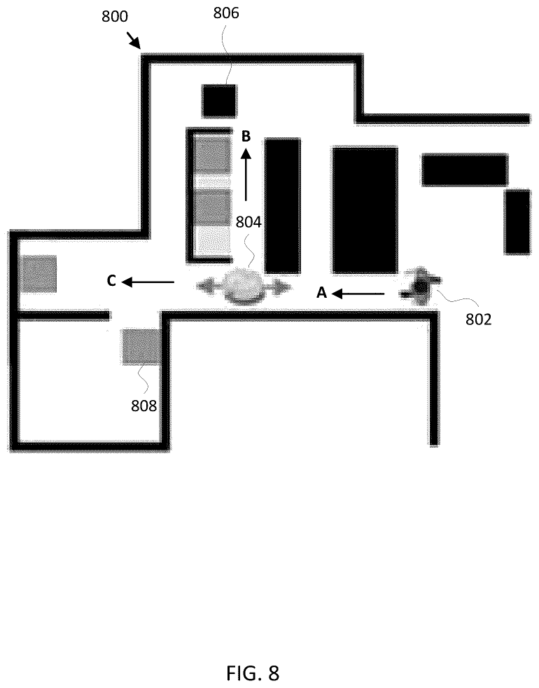

FIG. 8 illustrates an example environment in which a person 802 is observed walking and an autonomous robot 804 is operating. The autonomous robot 804 may be a vacuum cleaner. The environment 800 may include a fridge 806 and desk 808. The person 802 may be observed walking in direction “A”, which is obstructed by the robot 804. When image 700 is observed (e.g., person holding a bottle of milk), it may be determined that the person 802 is most likely to take a path towards the fridge 806. Therefore, the robot 804 may receive a control signal instructing the robot 804 to move in direction “C” to avoid obstructing the person 802 while the person 802 walks towards the fridge. When image 704 is observed (e.g., person holding a tablet), it may be determined that the person 802 is most likely to take a path towards the desk 808. Therefore, the robot 804 may receive a control signal instructing the robot 804 to move in direction “B” to avoid obstructing the person 802 while the person 802 walks towards the desk 808.

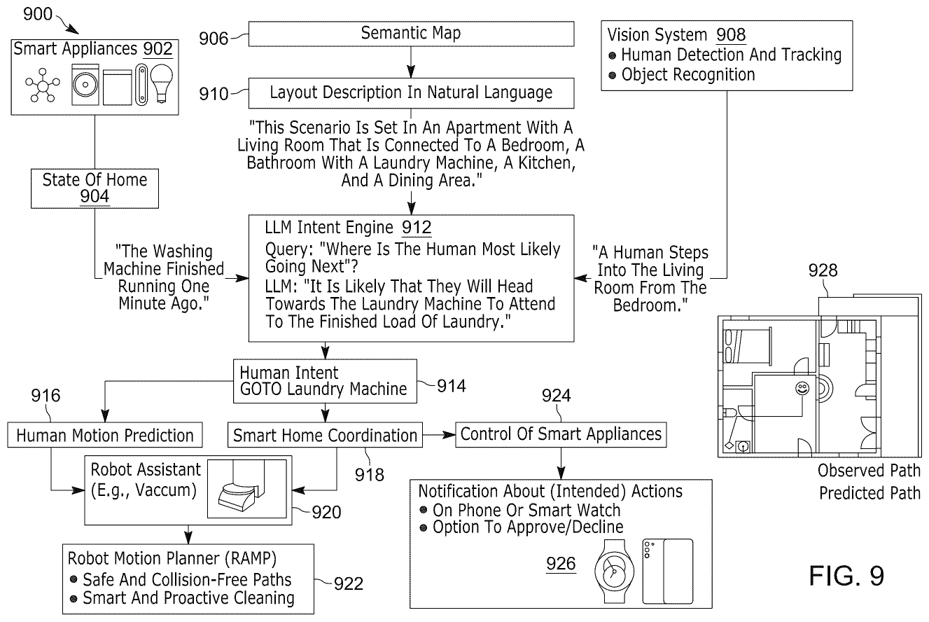

FIG. 9 illustrates a flowchart of an example process 900 based on one or more observations. The process 900 may be performed in accordance with the system architecture 500 (FIG. 5). Furthermore, process 900 may be performed by a processor such as processor 202 (FIG. 2).

In operation 902, observation data may be collected. For example, the observation data may be collected by one or more smart appliances, sensors, or cameras in an environment (e.g., home, apartment, etc.). In operation 904, a state of a home may be provided based on the observation data. For example, the state of the home may be determined as “The washing machine finished running one minute ago.”

In operation 906, a semantic map may be retrieved or generated, where in operation 908, the layout description in the natural language is extracted. For example, the semantic map may include a layout description specifying “This scenario is set in an apartment with a living room that is connected to a bedroom, a bathroom with a laundry machine, a kitchen, and a dining area.”

In operation 910, a vision system may detect one or more activities. For example, the vision system may include a camera that provides any one of images 700-704 that show a person carrying an object. The vision system may include a vision language model that receives an image to perform human detection and tracking and object detection. The vision system may provide the following narration “A human steps into the living room from the bedroom.”

In operation 912, an LLM Intent Engine 912 may receive the narration with the following query “Where is the human most likely going next?”. The LLM Intent Engine 912 may comprise an LLM that receives the narration and query. The LLM may output: “It is likely that they will head towards the laundry machine to attend to the finished load of laundry.”

In operation 914, a human intent may be determined based on the output of the LLM Intent Engine 912. For example, the Human intent may be predicted as “GOTO laundry machine.” The output of operation 914 may be used in operation 916 for human motion prediction and operation 918 for smart home coordination. In operation 916, a trajectory of a person may be predicted. For example, when one or more trajectories are available for a predicted destination, the trajectory that the person is most likely to take may be provided. FIG. 9 illustrates an example map 928 that shows an observed path along with a predicted path. The observed path may be a path observed by the vision system. The predicted path may be the path predicted in operation 914.

In operation 918, smart home coordination may be performed such as determining whether one or more appliances or robots need to be controlled. In operation 920, a robot assistant may be controlled to assist a person. In operation 922, a robot motion planner (RAMP) may be implemented to determine safe and collision-free paths. For example, based on a likely destination of a person, a vacuum cleaner may be instructed to take one or more paths to provide proactive cleaning. In operation 924 one or more smart appliances may be controlled. For example, if it is determined that a person is likely to go to the laundry machine, a control signal may be sent to the laundry machine instructing the laundry machine to turn off. In operation 926, a notification may be provided to one or more user devices (e.g., smart watch, phone), where one or more actions (e.g. operation laundry machine) is displayed on the device. The user may be provided the option to approve or decline the one or more actions.

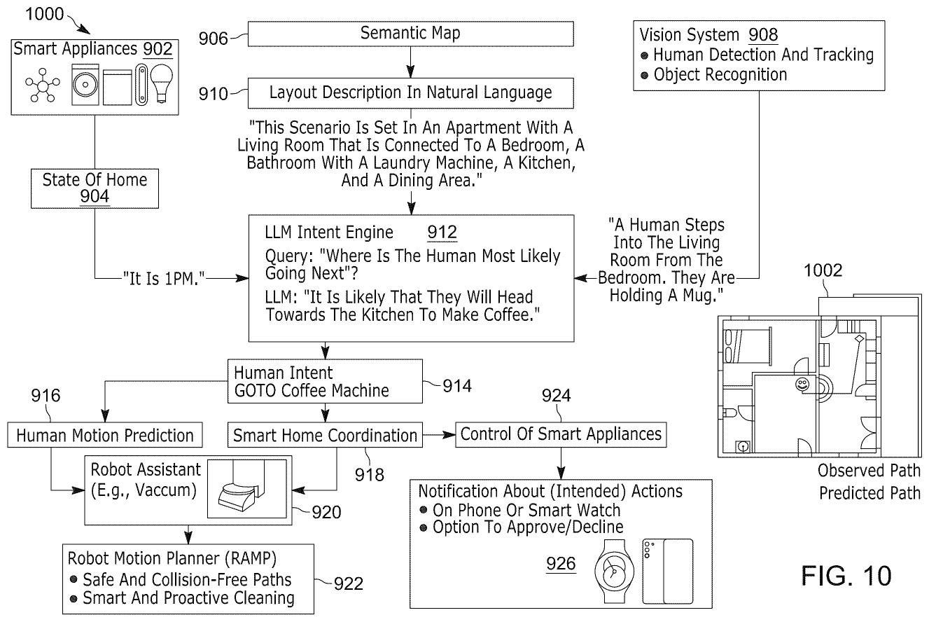

FIG. 10 illustrates a process 1000 based on the operation procedures described in FIG. 9, with different observations. For example, in operation 904, it may be determined that it is currently 1 pm. In operation 910, the vision system may determine that “A human steps into the living room from the bedroom they are holding a mug.” In operation 912, the LLM Intent Engine may determine that “It is likely that they will head towards the kitchen to make coffee.” In operation 914, the intent may be determined as “GOTO coffee machine.” Based on these determinations, a control signal may be sent to the coffee machine to turn on (operation 924). FIG. 10 further illustrates map 1002 that illustrates the observed path and the predicted path.

The embodiments have been described above and illustrated in terms of blocks, as shown in the drawings, which carry out the described function or functions. These blocks may be physically implemented by analog and/or digital circuits including one or more of a logic gate, an integrated circuit, a microprocessor, a microcontroller, a memory circuit, a passive electronic component, an active electronic component, an optical component, and the like, and may also be implemented by or driven by software and/or firmware (configured to perform the functions or operations described herein). The circuits may, for example, be embodied in one or more semiconductor chips, or on substrate supports such as printed circuit boards and the like. Circuits included in a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks. Likewise, the blocks of the embodiments may be physically combined into more complex blocks.

While this disclosure has described several non-limiting embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the embodiments listed below:
(1) A method performed by at least one processor, the method comprising: receiving data from one or more sensors corresponding to a first time period; detecting, from the received data, one or more activities of a person in a space; converting the detected one or more activities into a natural language narration; combining the natural language narration with sequence text that corresponds to an action that is sequential to the detected one or more activities; extracting one or more items from a map corresponding to the space; determining a relevancy score for each of the extracted one or more items based on an output of a language model that receives as input the combination of the narration with the sequence text; correlating the extracted one or more items with one or more locations on the map based on the determined relevancy for each of the extracted one or more items; and outputting a control signal for controlling a movement of one more devices based on the correlation of the extracted one or more items with the one or more locations on the map.
(2) The method according to feature (1), in which the correlating the extracted one or more items with the one or more locations on the map further comprises: aggregating the relevancy score of each of the one or more items belonging to a same partition in the map; in which a first partition in the map having a higher aggregated relevancy score than a second partition in the map represents a higher likelihood that the person will be located in the first partition than the second partition during the second time period.
(3) The method according to feature (2), in which the outputting the control signal for controlling the movement of the one or more devices is based on the aggregated relevancy score of each partition in the map.
(4) The method according to any one of features (1)-(3), in which the correlating the extracted one or more items with the one or more locations on the map further comprises: determining, for each path from the person's current location to the one or more locations on the map, a likelihood that a respective path will be traversed.
(5) The method according to any one of features (1)-(4), in which the map includes, for each extracted item, a semantic label, a position, and a bounding box.
(6) The method according to any one of features (1)-(5), in which each of the extracted one or more items are located at a distance from the person that is less than or equal to a distance threshold.
(7) The method according to any one of features (1)-(6), in which the language model is a large language model (LLM) trained on a text corpus.
(8) The method according to any one of features (1)-(7), in which the one or more devices comprises an autonomous robot.
(9) The method according to feature (8), in which the outputting the control signal for controlling the movement of the one or more devices further comprises: causing the autonomous robot to avoid the person during the second time period.
(10) The method according to feature (8), in which the outputting the control signal for controlling the movement of the one or more devices further comprises: causing the autonomous robot to assist the person during the second time period.
(11) An apparatus comprising: a memory; processing circuitry coupled to the memory, the processing circuitry configured to: receive data from one or more sensors corresponding to a first time period, detect, from the received data, one or more activities of a person in a space, convert the detected one or more activities into a natural language narration; combine the natural language narration with sequence text that corresponds to an action that is sequential to the detected one or more activities, extract one or more items from a map corresponding to the space, determine a relevancy score for each of the extracted one or more items based on an output of a language model that receives as input the combination of the narration with the sequence text, correlate the extracted one or more items with one or more locations on the map based on the determined relevancy for each of the extracted one or more items, and a control signal for controlling a movement of one more devices based on the correlation of the extracted one or more items with the one or more locations on the map.
(12) The apparatus according to feature (11), in which the correlation of the extracted one or more items with the one or more locations on the map comprises the processing circuitry further configured to: aggregate the relevancy score of each of the one or more items belonging to a same partition in the map, in which a first partition in the map having a higher aggregated relevancy score than a second partition in the map represents a higher likelihood that the person will be located in the first partition than the second partition during the second time period.
(13) The apparatus according to feature (12), in which the control of the operation of the one or more devices is based on the aggregated relevancy score of each partition in the map.
(14) The apparatus according to any one of features (11)-(13), in which the correlation of the extracted one or more items with the one or more locations on the map comprises the processing circuitry further configured to: determine, for each path from the person's current location to the one or more locations on the map, a likelihood that the respective path will be traversed.
(15) The apparatus according to any one of features (11)-(14), in which the map includes, for each extracted item, a semantic label, a position, and a bounding box.
(16) The apparatus according to any one of features (11)-(16), in which each of the extracted one or more items are located at a distance from the person that is less than or equal to a distance threshold.
(17) The apparatus according to any one of features (11)-16), in which the language model is a large language model (LLM) trained on a text corpus.
(18) The apparatus according to any one of features (11)-(17), in which the one or more devices comprises an autonomous robot.
(19) The apparatus according to feature (8), in which the processing circuitry is further configured to output the control signal to control an operation of the autonomous robot to avoid the person during the second time period.
(20) A non-transitory computer readable medium having instructions stored therein, which when executed by a processor cause the processor to execute a method comprising: receiving data from one or more sensors corresponding to a first time period, detecting, from the received data, one or more activities of a person in a space, converting the detected one or more activities into a natural language narration; combining the natural language narration with sequence text that corresponds to an action that is sequential to the detected one or more activities; extracting one or more items from a map corresponding to the space; determining a relevancy score for each of the extracted one or more items based on an output of a language model that receives as input the combination of the narration with the sequence text; correlating the extracted one or more items with one or more locations on the map based on the determined relevancy for each of the extracted one or more items; and outputting a control signal for controlling a movement of one more devices based on the correlation of the extracted one or more items with the one or more locations on the map.

What is claimed is:

1. A method performed by at least one processor, the method comprising:
receiving data from one or more sensors corresponding to a first time period;
detecting, from the received data, one or more activities of a person in a space;
converting the detected one or more activities into a natural language narration;
combining the natural language narration with sequence text that corresponds to an action that is sequential to the detected one or more activities;
extracting one or more items from a map corresponding to the space;
determining a relevancy score for each of the extracted one or more items based on an output of a language model that receives as input the combination of the narration with the sequence text;
correlating the extracted one or more items with one or more locations on the map based on the determined relevancy for each of the extracted one or more items; and
outputting a control signal for controlling a movement of one more devices based on the correlation of the extracted one or more items with the one or more locations on the map.

2. The method according to claim 1, wherein the correlating the extracted one or more items with the one or more locations on the map further comprises:
aggregating the relevancy score of each of the one or more items belonging to a same partition in the map;
wherein a first partition in the map having a higher aggregated relevancy score than a second partition in the map represents a higher likelihood that the person will be located in the first partition than the second partition during the second time period.

3. The method according to claim 2, wherein the outputting the control signal for controlling the movement of the one or more devices is based on the aggregated relevancy score of each partition in the map.

4. The method according to claim 1, wherein the correlating the extracted one or more items with the one or more locations on the map further comprises:
determining, for each path from the person's current location to the one or more locations on the map, a likelihood that a respective path will be traversed.

5. The method according to claim 1, wherein the map includes, for each extracted item, a semantic label, a position, and a bounding box.

6. The method according to claim 1, wherein each of the extracted one or more items are located at a distance from the person that is less than or equal to a distance threshold.

7. The method according to claim 1, wherein the language model is a large language model (LLM) trained on a text corpus.

8. The method according to claim 1, wherein the one or more devices comprises an autonomous robot.

9. The method according to claim 8, wherein the outputting the control signal for controlling the movement of the one or more devices further comprises:
causing the autonomous robot to avoid the person during the second time period.

10. The method according to claim 8, wherein the outputting the control signal for controlling the movement of the one or more devices further comprises:
causing the autonomous robot to assist the person during the second time period.

11. An apparatus comprising:
a memory;
processing circuitry coupled to the memory, the processing circuitry configured to:
receive data from one or more sensors corresponding to a first time period,
detect, from the received data, one or more activities of a person in a space,
convert the detected one or more activities into a natural language narration;
combine the natural language narration with sequence text that corresponds to an action that is sequential to the detected one or more activities,
extract one or more items from a map corresponding to the space,
determine a relevancy score for each of the extracted one or more items based on an output of a language model that receives as input the combination of the narration with the sequence text,
correlate the extracted one or more items with one or more locations on the map based on the determined relevancy for each of the extracted one or more items, and
a control signal for controlling a movement of one more devices based on the correlation of the extracted one or more items with the one or more locations on the map.

12. The apparatus according to claim 11, wherein the correlation of the extracted one or more items with the one or more locations on the map comprises the processing circuitry further configured to:
aggregate the relevancy score of each of the one or more items belonging to a same partition in the map,
wherein a first partition in the map having a higher aggregated relevancy score than a second partition in the map represents a higher likelihood that the person will be located in the first partition than the second partition during the second time period.

13. The apparatus according to claim 12, wherein the control of the operation of the one or more devices is based on the aggregated relevancy score of each partition in the map.

14. The apparatus according to claim 11, wherein the correlation of the extracted one or more items with the one or more locations on the map comprises the processing circuitry further configured to:
determine, for each path from the person's current location to the one or more locations on the map, a likelihood that the respective path will be traversed.

15. The apparatus according to claim 11, wherein the map includes, for each extracted item, a semantic label, a position, and a bounding box.

16. The apparatus according to claim 11, wherein each of the extracted one or more items are located at a distance from the person that is less than or equal to a distance threshold.

17. The apparatus according to claim 11, wherein the language model is a large language model (LLM) trained on a text corpus.

18. The apparatus according to claim 11, wherein the one or more devices comprises an autonomous robot.

19. The apparatus according to claim 18, wherein the processing circuitry is further configured to output the control signal to control an operation of the autonomous robot to avoid the person during the second time period.

20. A non-transitory computer readable medium having instructions stored therein, which when executed by a processor cause the processor to execute a method comprising:
receiving data from one or more sensors corresponding to a first time period,
detecting, from the received data, one or more activities of a person in a space,
converting the detected one or more activities into a natural language narration;
combining the natural language narration with sequence text that corresponds to an action that is sequential to the detected one or more activities;
extracting one or more items from a map corresponding to the space;
determining a relevancy score for each of the extracted one or more items based on an output of a language model that receives as input the combination of the narration with the sequence text;
correlating the extracted one or more items with one or more locations on the map based on the determined relevancy for each of the extracted one or more items; and
outputting a control signal for controlling a movement of one more devices based on the correlation of the extracted one or more items with the one or more locations on the map.
